(19) United States
(12) Patent Application Publication
(10) Pub. No.: US 2014/0173499 A1
(43) Pub. Date: Jun. 19, 2014

(54) SYSTEMS AND METHODS FOR INTEGRATING STORAGE USAGE INFORMATION

(71) Applicant: David Wicks, Houston, TX (US)

(72) Inventor: David Wicks, Houston, TX (US)

(73) Assignee: Chevron U.S.A. Inc., San Ramon, CA (US)

(21) Appl. No.: 13/715,125

(22) Filed: Dec. 14, 2012

(51) Int. Cl. G06F 3/0482

(52) U.S. Cl. CPC G06F 3/0482
USPC 715/781

(57) ABSTRACT

Systems and methods for integrating storage usage information are disclosed. In some implementations, a method includes, at a computer system, displaying, in a first pane, a portion of a hierarchical data structure having a plurality of structural elements. A user selection of a structural element, which includes a plurality of sub-elements, is obtained. In response to the user selection of the structural element: a first grid including: (a) user identifiers, (b) storage usage information corresponding to the user identifiers, in accordance with predefined time ranges, and (c) total storage usage information corresponding to the user identifiers is displayed in a second pane. Further, a second grid including: (a) a first ranked plurality of sub-elements and (b) storage usage information corresponding to the first ranked plurality of sub-elements is also displayed in a third pane.

### TECHNICAL FIELD

The disclosed implementations relate generally to integrating storage usage information.

### BACKGROUND

Managing storage space shared among many users or teams is often difficult. The need to manage disk space means the user often reviews several data attributes, such as file size or file type, when deciding whether to remove or archive certain data.

Difficulties abound, however, not only because conventional storage space management software does not provide a comprehensive and yet integrated view of these data attributes; but also because collecting and viewing data attributes in real time (e.g., online) significantly but often needlessly decreases system performance for other users attempting to access the same resource.

### SUMMARY

The above identified difficulties are reduced or eliminated by the systems and methods disclosed herein. In some embodiments, a method is provided in which at a computer system, in a first pane of a window having a plurality of panes, all or a portion of a hierarchical data structure having a plurality of structural elements is displayed. The plurality of structural elements includes a user selected parent element. The user selected parent element is a boundary condition for a corresponding scan of a datastore. In the method, a user selection of a structural element is obtained from the plurality of structural elements. This structural element includes a plurality of sub-elements. In response to the user selection of the structural element, a second pane in the plurality of panes is displayed. the first grid includes (a) a plurality of user identifiers, (b) storage usage information corresponding to the plurality of user identifiers, in accordance with a plurality of predefined time ranges, and (c) total storage usage information corresponding to the plurality of user identifiers. The plurality of user identifiers is ranked in accordance with user identifier, a predefined time range in the plurality of predefined time ranges, or the total storage usage information. In a third pane of the plurality of panes, a second grid is displayed. The second grid includes (a) a first ranked plurality of sub-elements, and (b) storage usage information corresponding to the first ranked plurality of sub-elements.

In some embodiments, the image file corresponding to all or a portion of the datastore is generated by scanning the datastore in accordance with the boundary condition. In such embodiments, the image file serves as the corresponding scan of the datastore. In some embodiments this generating is performed in accordance with a predefined schedule without user intervention, or in response to a user request.

In some embodiments, the method further comprises displaying, concurrently with the plurality of panes, a timestamp associated with the corresponding scan of the datastore. In some embodiments, the method further comprises resizing two or more panes in the plurality of panes in accordance with a resize of any one pane in the plurality of panes.

In some embodiments, the method further comprises displaying a third grid, the third grid comprising: (a) a second plurality of sub-elements, (b) one or more user identifiers associated with the second plurality of sub-elements, (c) storage usage information corresponding to the second plurality of sub-elements, and (d) one or more last modification timestamps associated with the second plurality of sub-elements. The second plurality of sub-element is ranked in accordance with user identifier, last modification timestamp, or the storage usage information. In some instances, the second plurality of sub-elements is ranked, without user intervention, upon activating the display of the third grid.

Another aspect provides a computer system, comprising one or more processors, memory, and one or more programs. The one or more programs are stored in the memory and are configured to be executed by the one or more processors. The one or more programs including instructions for displaying, in a first pane of a window having a plurality of panes, all or a portion of a hierarchical data structure having a plurality of structural elements. The plurality of structural elements includes a user selected parent element. This user selected parent element is a boundary condition for a corresponding scan of a datastore. The one or more programs further include instructions for obtaining a user selection of a structural element from the plurality of structural elements. This structural element includes a plurality of sub-elements. In response to the user selection of the structural element, the one or more programs include instructions for displaying, in a second pane of the plurality of panes, a first grid including: (a) a plurality of user identifiers, (b) storage usage information corresponding to the ranked plurality of user identifiers, in accordance with a plurality of predefined time ranges, and (c) total storage usage information corresponding to the ranked plurality of user identifiers. The plurality of users identifier is ranked in accordance with user identifier, a predefined time range in the plurality of predefined time ranges, or the total storage usage information. The one or more programs include instructions for displaying, in a third pane of the plurality of panes, a second grid comprising: (a) a first ranked plurality of sub-elements, and (b) storage usage information corresponding to the first ranked plurality of sub-elements.

In some embodiments the one or more programs further comprise instructions for generating an image file corresponding to all or a portion of the datastore by scanning the datastore in accordance with the boundary condition. In such embodiments this image file serves as the corresponding scan of the datastore. In some embodiments, this generating step is performed in accordance with a predefined schedule without user intervention, or in response to a user request.

In some embodiments, the one or more programs further comprises instructions for displaying, concurrently with the plurality of panes, a timestamp associated with the corresponding scan of the datastore. In some embodiments, the one or more programs further comprises instructions for resizing two or more panes in the plurality of panes in accordance with a resize on any one pane in the plurality of panes. In some embodiments, the one or more programs further comprises instructions for displaying a third grid, including (a) a second plurality of sub-elements, (b) one or more user identifiers associated with the second plurality of sub-elements, (c) storage usage information corresponding to the second plurality of sub-elements, and (d) one or more last modification timestamps associated with the second plurality of sub-elements. The second plurality of sub-element is ranked in accordance with user identifier, last modification timestamp, or the storage usage information.

In some embodiments, the one or more programs further comprises instructions for ranking the second plurality of sub-elements, without user intervention, upon activating the display of the third grid.

Another aspect of the present disclosure provides a non-transitory computer readable storage medium storing one or more programs. The one or more programs comprise instructions, which when executed by a computer system with one or more processors, cause the computer system to display, in a first pane of a window having a plurality of panes, all or a portion of a hierarchical data structure having a plurality of structural elements. The plurality of structural elements includes a user selected parent element. The user selected parent element is a boundary condition for a corresponding scan of a datastore. The one or more programs comprise instructions for obtaining a user selection of a structural element from the plurality of structural elements. The structural element includes a plurality of sub-elements. In response to the user selection of the structural element, the one or more programs comprise instructions for displaying, in a second pane of the plurality of panes, a first grid including (a) a plurality of user identifiers, (b) storage usage information corresponding to the ranked plurality of user identifiers, in accordance with a plurality of predefined time ranges, and (c) total storage usage information corresponding to the ranked plurality of user identifiers. The plurality of users identifier is ranked in accordance with user identifier, a predefined time range in the plurality of predefined time ranges, or the total storage usage information. The one or more programs further comprise instructions for displaying, in a third pane of the plurality of panes, a second grid including: (a) a first ranked plurality of sub-elements, and (b) storage usage information corresponding to the first ranked plurality of sub-elements.

In some embodiments, the non-transitory computer readable storage medium further comprises instructions which cause the computer system to generate an image file corresponding to all or a portion of the datastore by scanning the datastore in accordance with the boundary condition. In such embodiments, the image file serves as the corresponding scan of the datastore. In some embodiments, the generating is performed upon a predefined schedule without user intervention, or upon a user demand. In some embodiments, the one or more programs further comprise instructions which cause the computer system to display, concurrently with the plurality of panes, a timestamp associated with the image file.

In some embodiments, the one or more programs further comprise instructions which cause the computer system to resize display of two or more panes in the plurality of panes in accordance with a resize on any one pane of the plurality of panes. In some embodiments, the one or more programs further comprise instructions which cause the computer system to display a third grid that includes (a) a second plurality of sub-elements, (b) one or more user identifiers associated with the second plurality of sub-elements, (c) storage usage information corresponding to the second plurality of sub-elements, and (d) one or more last modification timestamps associated with the second plurality of sub-elements. In such embodiments, the second plurality of sub-elements is ranked in accordance with user identifier, last modification timestamp, or the storage usage information.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is a block diagram illustrating a distributed system, in accordance with some implementations.

FIG. 2 is a block diagram illustrating a computer system, in accordance with some implementations.

FIG. 3 is a flow chart illustrating a method for integrating storage usage information in a distributed system, in accordance with some implementations.

FIGS. 4A-4B provide flowcharts illustrating a method for integrating storage usage information at a computer system, in accordance with some implementations.

FIGS. 5A-5G are screen images illustrating example portions of a user interface for integrating storage usage information, in accordance with some implementations.

### DETAILED DESCRIPTION

The implementations described herein provide advantageous techniques for integrating storage usage information. These techniques enable a user (e.g., a system administrator) to view many key data attributes—e.g., total storage usage, storage usage by ownership, age or project association—in an integrated or unified fashion, without the attendant cost of competing system resource (e.g., data access and computing power) with other users. For example, consider a situation where a system administrator is deciding whether to archive a directory including thousands of individual files and subdirectories shared across several workgroups. Some implementations disclosed herein allow the system administrator to gather key data attributes, for example, when data access requests by other users are at a minimum (e.g., during non-working hours or over a weekend). This is accomplished, in some implementations, by scanning directories or files to capture key data attributes into a disk image file (e.g., an XML file) that can then be analyzed offline. In some situations, the scanning process is automatically started in response to a trigger event, such as when available storage capacity is less than a threshold amount (e.g. 10%) of the total storage capacity. In other situations, the scanning process is started in response to a specific request by the system administrator.

Some implementations then allow the system administrator to view the key data attributes previously collected—offline—in a unified or integrated fashion. In some implementations, a directory selected by the system administrator and its subdirectories are displayed in an expandable tree view in a first pane. In addition, storage usage information categorized by file age is displayed in a second pane, and size of each subdirectory is displayed in a third pane. In the expanded tree view, the system administrator can drill down to any directory in the directory tree, and concurrently review storage usage for the selected directory and subdirectory thereunder (e.g., in an age-versus-ownership table) in the second and third panes.

In this way, a comprehensive and yet integrated view of many important data attributes is provided to a system administrator (or other users) to facilitate their decisions as to which data should be left intact, or which data should be removed or archived to make room for new data—for example, which directories have not been accessed or modified for an extended period of time, suggesting little usage; or which users have consumed a large amount of storage space, indicating inefficient storage management.

These approaches are beneficial in that key data attributes are captured with only a minimum impact, if any at all, on system performance; and storage management decisions can be promptly made when facilitated by an integrated view of key data attributes.

Additional details of implementations are now described in relation to the Figures.

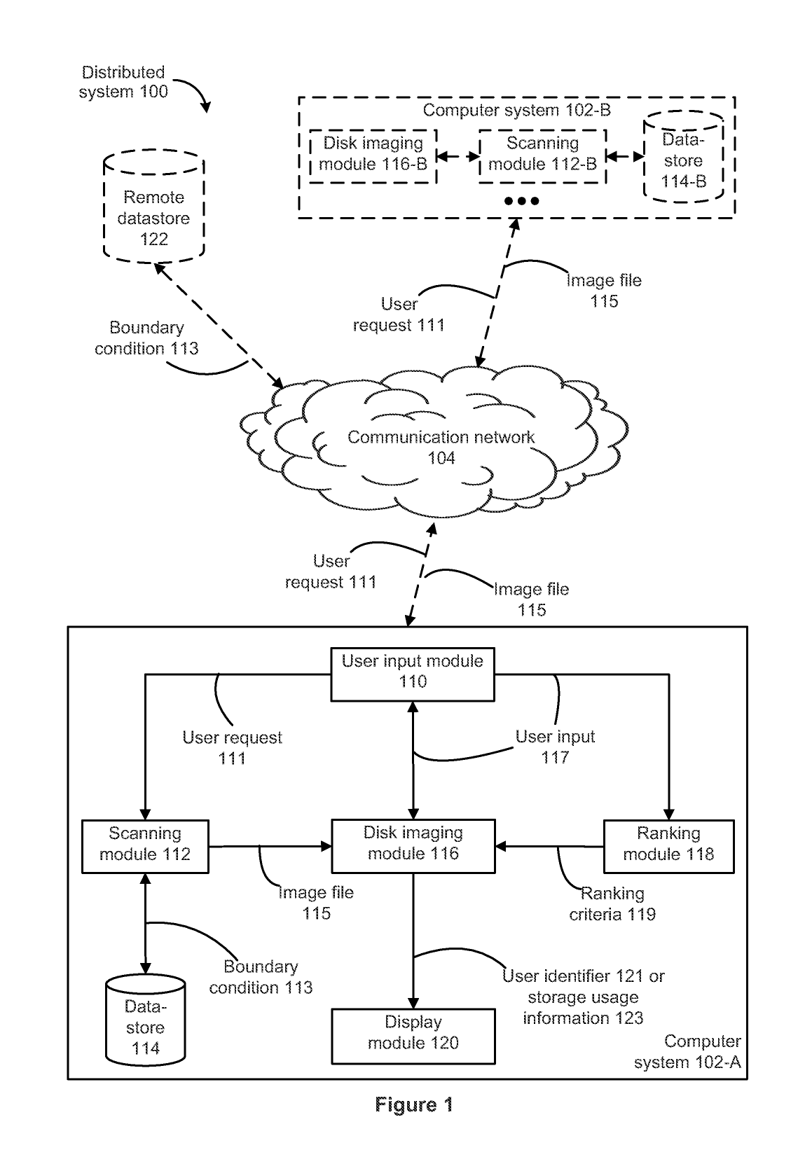

FIG. 1 is a block diagram illustrating a distributed system, in accordance with some implementations. In some implementations, the distributed system 100 includes one or more computer systems 102 (“computers 102”; e.g., the computer 102-A and the computer 102-B), a communication network 104, and optionally a remote datastore 122.

In some implementations, a computer 102-A (e.g., a server, a desktop, a laptop, a phone, or a tablet) includes a user input module 110, a scanning module 112, a datastore 114, a disk imaging module 116, a ranking module 118, and a display module 120. In some implementations, a user input module 110 obtains a user request 111 from a user (e.g., a system or database administrator) of the computer 102-A, and transmits the user request 111 to the scanning module 112. In some implementations, the user input module obtains the user request 111 from another computer 102 (e.g., computer 102-B), via the communication network 104. For example, a user of the computer 102-B can analyze storage (e.g., volatile storage or nonvolatile storage) usage of the computer 102-A, even if the computers 102-A and 102-B are remote from each other (e.g., located in different geographical regions or belong to different computer networks), and vice versa. In another example, a system administrator (e.g., using the computer 102-A) can remotely manage data stored on a regular user's computer (e.g., computer 102-B), by sending a user request 111 to the user's computer. In some implementations, a user request 111 includes one or more parameters specifying a boundary condition 113 of a scan (the scope of the scan; e.g., a particular directory) and how the scan is to be executed (e.g., when to start the scan, or a particular output format for scan results).

In some implementations, the scanning module 112 scans the datastore 114, in accordance with the boundary condition 113. For example, in accordance with the boundary condition 113, the scanning module 112 scans a particular portion of the datastore 114 (e.g., disk partitions associated with a specific workgroup or project), or a particular type of data stored on the datastore 114 (e.g., directories but not files, or images and videos but not text files). In some implementations, the scanning module 112 scans a datastore remote from the computer 102-A (e.g., the remote datastore 122 or the datastore 114-B). In some implementations, after completing a scan, the scanning module 112 outputs scan results into an image file 115 (e.g., an XML file or a spreadsheet) to the disk imaging module 116, where further processing (e.g., sorting or formatting) can be done.

In some implementations, where different portions of the same data set (e.g., different subdirectories under a same parent directory) are stored on two or more datastores (e.g., on both the datastore 114 and the remote datastore 122), the scanning module 112 identifies two or more separate boundary conditions using the original boundary condition 113, and sends different boundary conditions to their respectively applicable datastores, where scans are executed in parallel or in a predefined sequence (thereby reducing time required for producing scan results for the whole data set), and scan results are selectively merged, in part or in full, to produce a complete image file 115.

For example, after receiving a user request for a scan of a directory having 300 files (the first 100 of which are stored on the datastore 114 of computer 102-A, and the remaining 200 of which are stored on the datastore 114-B of computer 102-B), the scanning module 112 on computer 102-A sends one boundary condition specifying the first 100 files to the datastore 114, and additionally sends another boundary condition specifying the remaining 200 files to datastore 114-B. Scan results from the datastore 114 are selectively merged (in full or in part) with those from the datastore 114-B to produce a complete image file 115 for the directory. This approach is beneficial not only because it allows for parallel or pipeline processing, thereby reducing total response time, but also because it provides data severability, thereby increasing overall flexibility and robustness. For example, this approach allows partial execution on partially available data in the event of a system failure (e.g., a malfunction on the remote datastore 122), or partial execution by design or by preference, such as executing different portions of a same scan at different timings (e.g., the first portion at 2 PM and the second portion at 5 PM) so as to avoid different peak demand period in different time zones (e.g., EST and PST, respectively).

In some implementations, where two or more datastores (e.g., the datastore 114 and the datastore 114-B) include overlapping data (e.g., same replicates of a same file or directory), scanning module 112 sends the same boundary condition 113 to the two or more datastores, where scans can be executed in parallel and the first available scan results are used to produce the image file 115. This approach is also beneficial, because it takes advantage of the existing data redundancy, thereby enhancing system performance.

In some implementations, the datastore 114 stores data (e.g., files and directories) using one or more hierarchical data structure (e.g., tree, linear, flat, or overlapping structures) having one or more structural elements (e.g., subdirectories or files). In some implementations, the datastore 114 also stores metadata, for example, ownership, project association, access privilege (e.g., read or write permission), or creation or last modification/access timestamp associated with a file or directory.

In some implementations, the disk imaging module 116 formats the image file 115 (e.g., the XML file) received from the scanning module 112, and presents data (e.g., user identifiers 121 or storage usage information 123) included in the image file 115 or a portion thereof, for display by the display module 120. For example, the disk imaging module 116 ranks or sorts data stored in the image file 115 in accordance with one or more ranking criteria 119 (e.g., user identifier, last modification time stamp, or file size) provided by the ranking module 118. In another example, the disk imaging module 116 organizes data (e.g., files and directories) for display using metadata (e.g., directory relationship) included in the image file 115.

In some implementations, the ranking module 118 receives a user input 117 (e.g., a click on a column header displayed in a grid) and produces one or more ranking criteria 119 in accordance with the user input 117.

In some implementations, the display module 120 formats and displays, using one or more user interface controls (e.g., a window, a pane, a grid, a table, or a splitter), data received from the disk imaging module 116. In some implementations, the display module 120 also coordinates the display of the one or more user interface controls. For example, after detecting a pane has been resized (e.g., enlarged or reduced in size) or changed in shape, the display module 120 resizes or reshapes the display of the remaining panes, so as to optimize display real estate.

In some implementations, the remote datastore 122 is remote (e.g., geographically, structurally, or organizationally) from the computer 102-A. In some instances, for example, the remote datastore 122 is located in a different physical location, belongs to a different computer network, or is assigned to a different workgroup or work division from the computer 102-A. In some implementations, the remote datastore 122 include duplicates of data stored on the datastore 114 or the datastore 114-B. In some implementations, the remote datastore 122 includes data different from but related to data stored on the datastore 114 or the datastore 114-B. For example, in some situations, the remote datastore 122 and the datastore 114 include different subdirectories under a same parent directory, where more frequently-accessed directories are stored on the datastore 114 and less frequently-accessed subdirectories are stored on the remote datastore 122. In some implementations, for example, when equipped with an appropriate level of computing power, the remote datastore 122 includes its own scanning module 112.

In some implementations, where there are multiple computer systems (e.g., computer 102-A and computer 102-B) that each includes a scanning module 112, workload associated with a scan is balanced among the multiple computer systems. For example, after receiving a user request for a scan of 1,000 directories and their associated files and subdirectories, computer 102-A sends a request to share workload to the computer 102-B. Once the request is approved, workload is spitted evenly or proportionally between the computers 102-A and 102-B, in accordance their respective processing power or workload at the time or within a predefined time period in the future. In some implementations, the workload is balanced only among the computers that include at least more than a predefined portion of the data included in a scan, so as to avoid excessive overheard. For example, only computers that include at least 10 subdirectories or file included in the 1,000 directories would be part of the load-balancing scheme. In other implementations, workload is balanced among all computers that have processing power available, so as to potentially maximize performance.

In some implementations, the communication network 104 optionally includes the Internet, one or more local area networks (LANs), one or more wide area networks (WANs), other types of networks, or a combination of such networks.

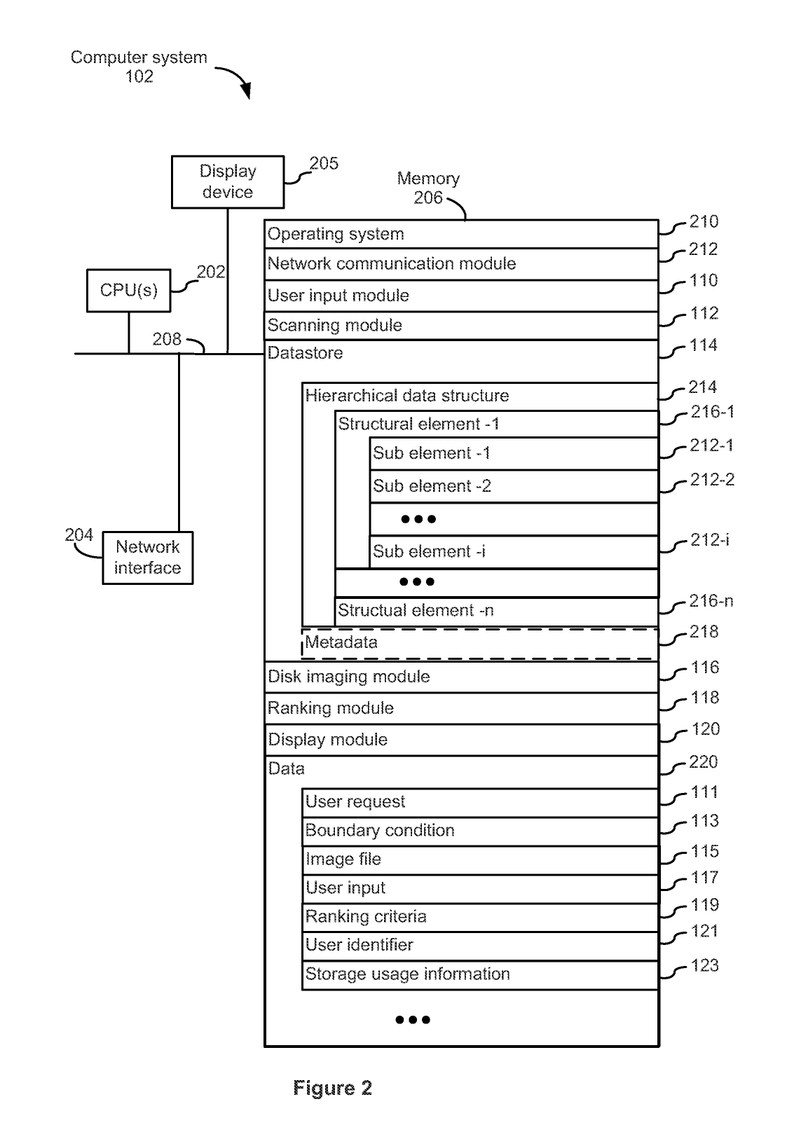

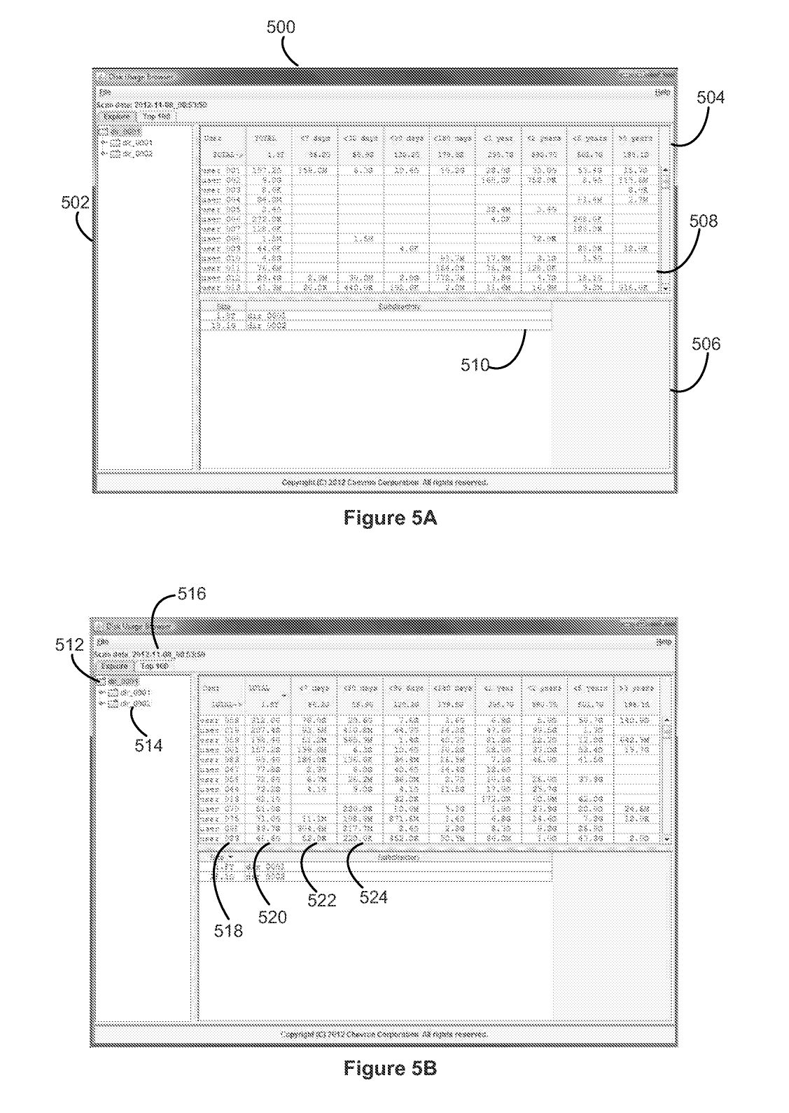

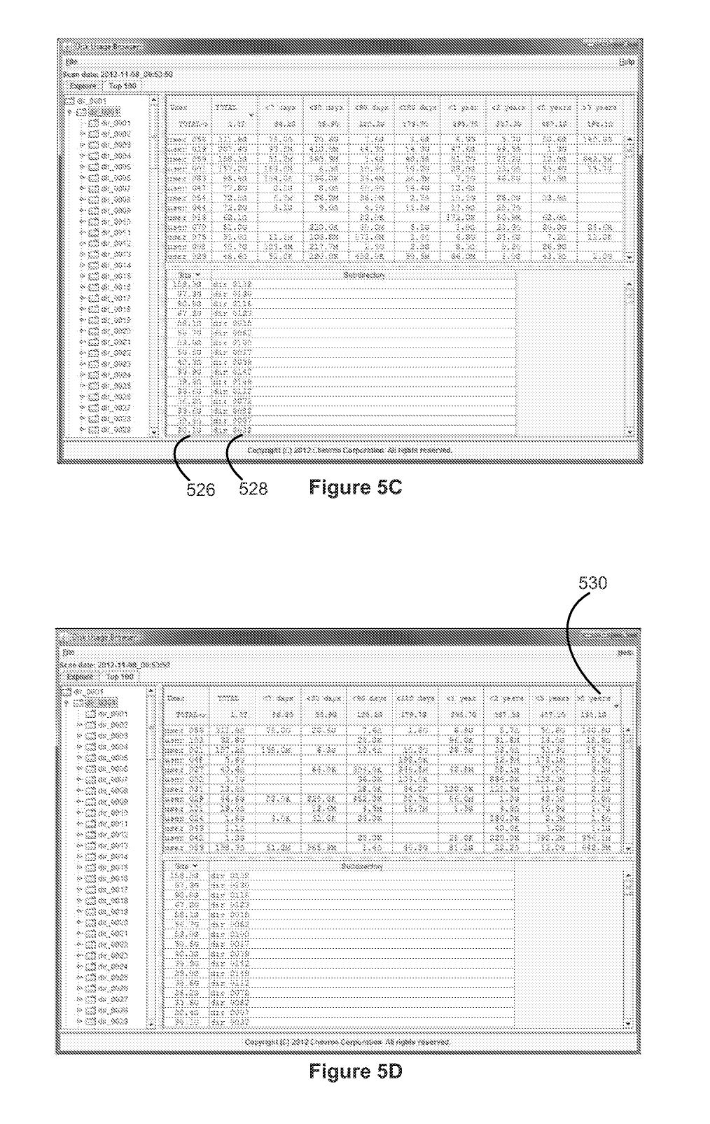

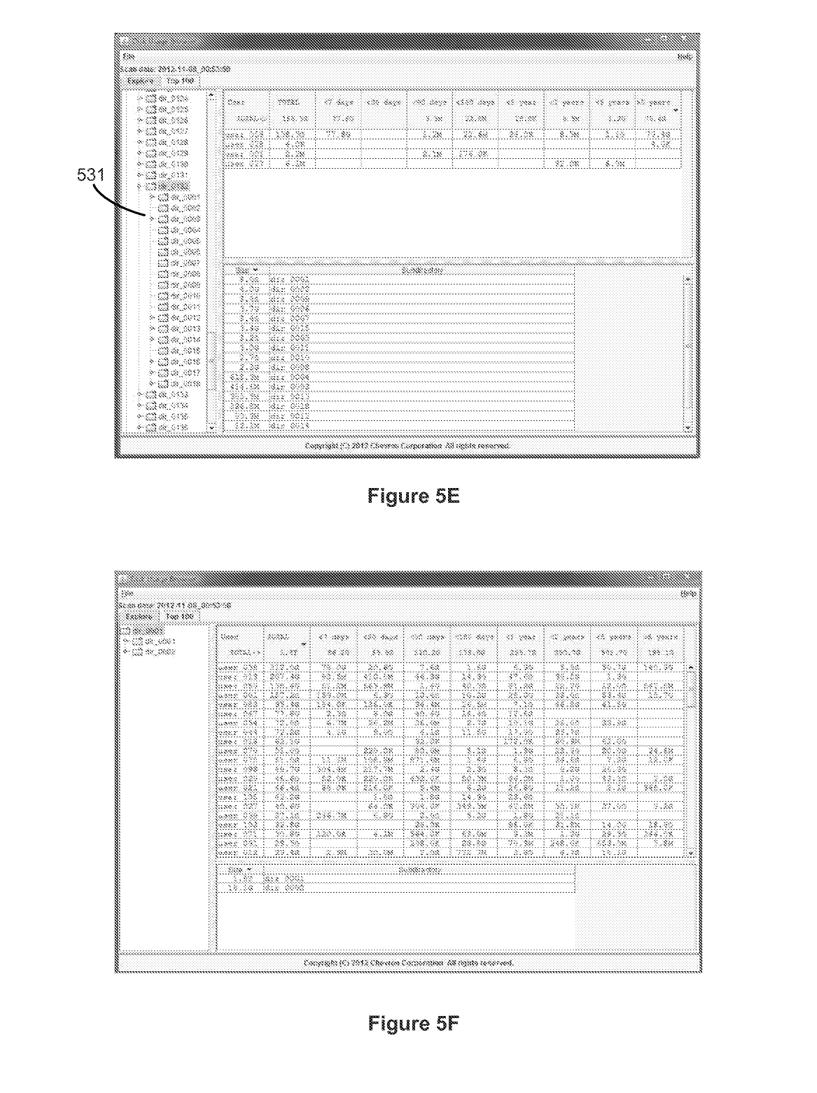

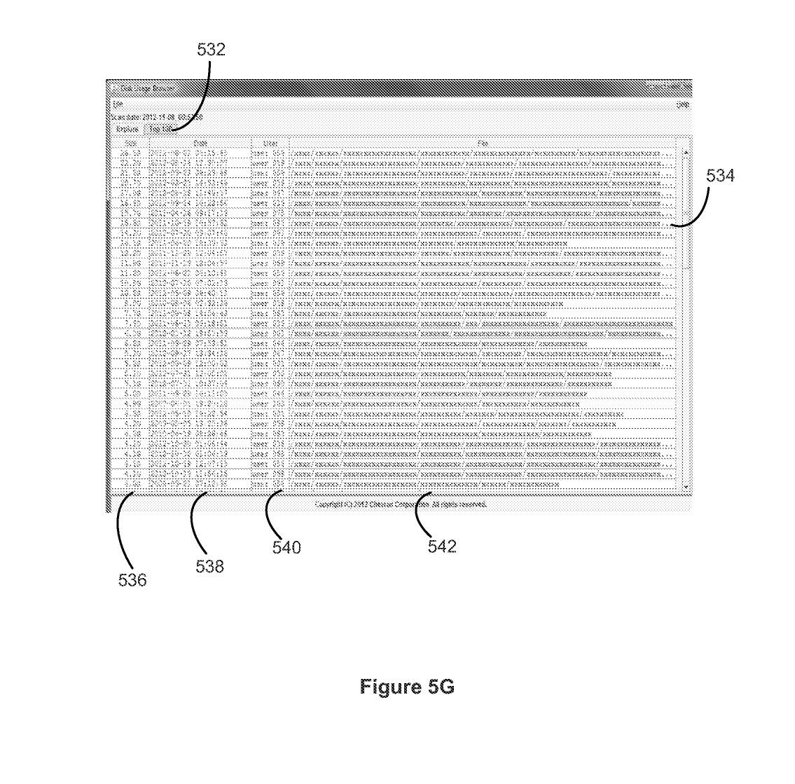

FIG. 2 is a block diagram illustrating a computer system 102 (“computer 102”), in accordance with some implementations. The computer 102, in some implementations, includes one or more processing units CPU(s) 202 (also herein referred to as processors), one or more network interfaces 204, a display device 205, memory 206, and one or more communication buses 208 for interconnecting these components. The communication buses 208 optionally include circuitry (sometimes called a chipset) that interconnects and controls communications between system components. The memory 206 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 206 optionally includes one or more storage devices remotely located from the CPU(s) 202. The memory 206, or alternately the non-volatile memory device(s) within the memory 206, comprises a non-transitory computer readable storage medium. In some implementations, the memory 206 or alternately the non-transitory computer readable storage medium stores the following programs, modules and data structures, or a subset thereof:
an operating system 210, which includes procedures for handling various basic system services and for performing hardware dependent tasks;
a network communication module (or instructions) 212 for connecting the computer 102 with other devices (e.g., another computer 102 or a remote datastore 122) via one or more network interfaces 204 (wired or wireless) or the communication network 104 (FIG. 1);
a user input module 110 for receiving a user request 111 or a user input 117, and for sending the use request 111 or a portion thereof (e.g., in a load balancing situation), to or another computer via the communication network 104;
a scanning module 112 for, in response to a user request or under a predefined schedule, scanning a datastore or a portion thereof, in accordance with a boundary condition 113 (e.g., specified in the user request), and for producing a corresponding image file 115 that includes scan results or a portion thereof;
a datastore 114 stored on the computer 102, which includes a hierarchical data structure 214 (e.g., a tree, linear, flat, or overlapping structure) for representing data and logical or physical relationship (e.g., relevancy) among individual datum included therein, the hierarchical data structure 214 including:
   a structural element 216-n, which corresponds to a set of data (e.g., a directory including several files and subdirectories), including:
      a sub-element 218-i, which corresponds to an individual file or subdirectory associated with the structural element 216-n; and
   metadata 218 for the hierarchical data structure 214, or a portion thereof, for example, a last modification/access timestamp associated with a structural element or a sub-element.
a disk imaging module 116 for ranking data included in the image file 115, or a portion thereof, in accordance with one or more ranking criteria 119, and for presenting the data or the portion thereof for display at the display module 120;
a ranking module 118 for identifying one or more ranking criteria 119 in accordance with a user input 117 (e.g., a click on a column header in a grid);
a display module 120 for displaying data presented by the disk imaging module 116, and for updating the display (e.g., in response to a predefined event or user action); and
data 220 stored on the computer 102, which includes:
   a user request 111 for including parameters relevant to a scan (e.g., request originator, when a request is to be executed, or whether a partial execution is desired);
   a boundary condition 113 for specifying the scope of the scan (e.g., which directories or files are included or excluded) in accordance with the user request 111;
   an image file 115 (e.g., an XML file) for including scan results (e.g. file or directory name), and metadata therefor (e.g., creation or last modification timestamp, project association, or ownership associated therewith);
   a user input 117 for including information representing one or more user actions on a user interface control (e.g., a click on a “User” column header in FIG. 5A);
   one or more ranking criteria 119 for specifying criteria (e.g., file age or ownership), in accordance of which data included in the image file 115 are ranked or displayed to a user; and
   storage usage information 123 for including storage usage associated with a selected file or directory (and optionally its subdirectories).

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 206 optionally stores a subset of the modules and data structures identified above. Furthermore, the memory 206 may store additional modules and data structures not described above.

Although FIG. 2 shows a “computer system 102,” also referred to as a computer, FIG. 2 is intended more as functional description of the various features which may be present in computer system than as a structural schematic of the implementations described herein. In practice, and as recognized by those of ordinary skill in the art, items shown separately could be combined and some items could be separated.

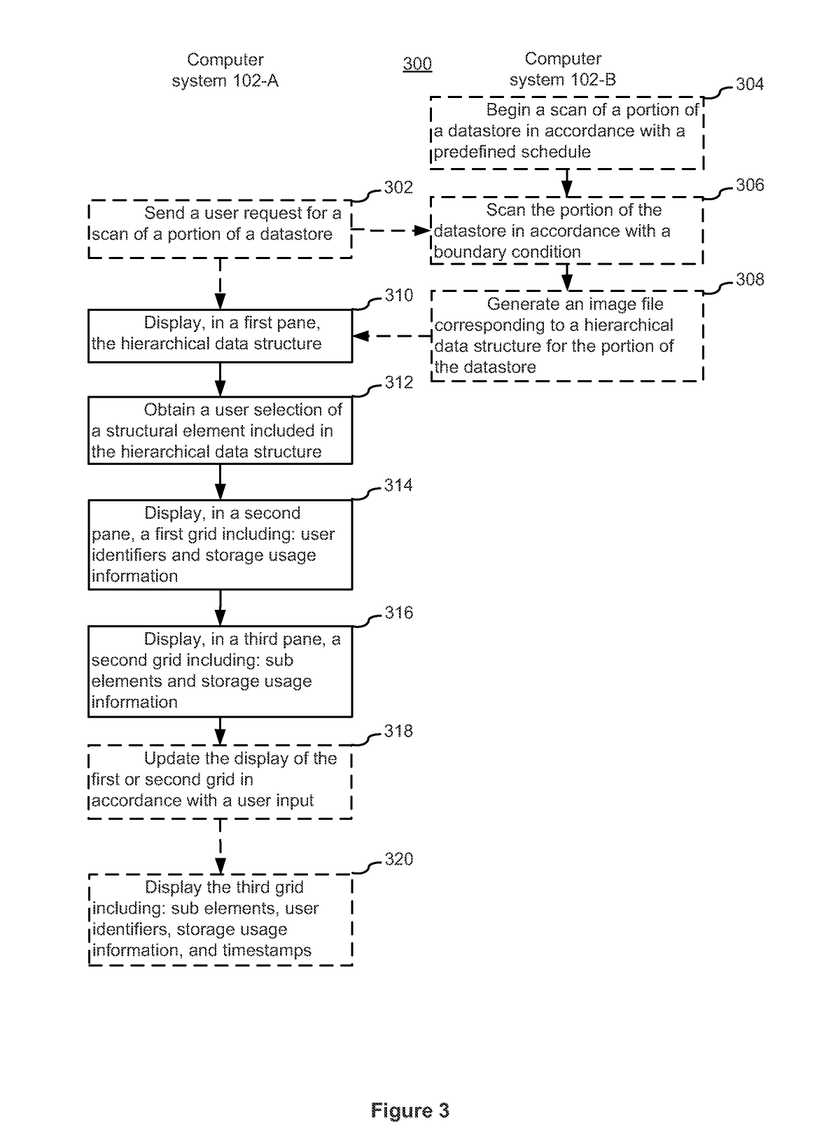

FIG. 3 is a flowchart illustrating a method 300 for integrating storage usage information in a distributed system, in accordance with some implementations.

In some implementations, a user (e.g., a system or database administrator) sends (302) a request for a scan of a portion of a datastore (e.g., a directory having one or more files and subdirectories) from one computer (e.g., the computer system 102-A) to another computer (e.g., the computer system 102-b). In some implementations, the computers 102-A and 102-B store (overlapping or non-overlapping) data corresponding to the portion of the datastore, and a load balancing process as described above is carried out between the computers 102-A and 102-B. In some implementations, the only computer 102-B (e.g., a dedicated data server), but not the computer 102-A (e.g., a thin-client), stores data corresponding to the portion of the datastore. In other implementations, neither of the computers 102-A and 102-B stores data corresponding to the portion of the datastore, and the user request is further forwarded or relayed by the computer 102-B (e.g., a data or gateway server with sufficient knowledge data distribution) to a third computer or a remote datastore where the portion of the datastore is stored. In some implementations, the determination as to which computer stores the portion of the datastore specified in a user request is made without user intervention (e.g., by a data server using a data distribution map or log), and the user request (or, in particular, the boundary condition specified in the user request) is forwarded in accordance with the determination.

In some implementations, the scan of the portion of the datastore is triggered in accordance with a predefined schedule (304) or in response to a trigger event. In some implementations, the predefined schedule includes secluding conditions such as, executing a scan of the root directory on partition C every week or every month, or executing a scan of partition D, the most frequently-accessed partition, during non-working hours only. In some implementations, a trigger event includes: when available storage capacity is less than a predefine percentage (e.g., 10% or 20%) of the total storage capacity; or when average response time for the past 1,000 data access requests fails to meet a threshold performance requirement (e.g., average response time for data access requests shall not exceed 5 milliseconds).

In some implementations, in response to the user request (or the trigger event), or in accordance with the predefined schedule, the computer 102-B scans (306) the portion of the datastore in accordance with a boundary condition (e.g., all files and subdirectory with a size greater than 1 GB under the directory “Projects_Already_Completed” on hard drive C) specified in the user request or the predefined schedule.

In some implementations, after scanning the selected portion of the datastore, the computer 102-B generates (308) an image file corresponding to a hierarchical data structure for the portion of the datastore, for example, an XML file having all directories and files greater than 1 GB under the directory “Projects_Already_Completed,” and relationship (e.g., directory hierarchy) between these directories and files.

In some implementations, the image file is transmitted back to the computer 102-A, which displays (310) the hierarchical data structure in a first pane (e.g., the pane 502 in FIG. 5A) in a window having a plurality of panes (e.g., the panes 502, 504, and 506 in FIG. 5A).

In some implementations, the computer 102-A obtains (312) a user selection (e.g., a click or a hover) of a structural element included in the hierarchical data structure. In some implementations, the structural element is one of the directories (e.g., the “dir_{—}0002” 514 in FIG. 5B) included in a directory tree displayed in the first pane.

In some implementations, in response to the user selection, the computer 102-A displays (314), in a second pane, a first grid (e.g., the grid 508 in FIG. 5A). In some implementations, the first grid includes: (a) a plurality of user identifiers, (b) storage usage information corresponding to the ranked plurality of user identifiers, in accordance with a plurality of predefined time ranges, and (c) total storage usage information corresponding to the ranked plurality of user identifiers, where the plurality of users identifier is ranked in accordance with user identifier, a predefined time range in the plurality of predefined time ranges, or the total storage usage information. In some implementations, the plurality of user identifiers includes user log-in names (e.g., user name 518 in FIG. 5B). In some implementations, the user identifiers are sorted and displayed alphabetically. In some implementations, the first grid also includes the storage usage information ranked in accordance with the ranked user identifiers. In some implementations, the first grid additional includes the storage usage information categorized using different time ranges, such as, less than 7 days, between 7 and 30 days, between 30 and 90 days, between 90 and 180 days, between 180 and 1 year, between 1 year and 2 years, between 2 year and 5 years, and more than 5 years. In some implementations, the time ranges are predefined; while in other implementations, the time ranges are customizable by a user. In some cases, additionally user-specified time ranges can be added to tailor to a particular user's or project's need. For example, the time range “more than 5 years” may be replaced with the time range “more than 5 weeks” for a recently-launched project. Categorizing storage space usage information into different time ranges is beneficial because it offers two-dimensional (e.g., usage and time) visual presentation and thus enables a user to promptly identify potential storage inefficiencies. In some implementations, the first grid further includes the total storage usage information associated with a particular user, for example, how much storage space a particular user has consumed. In some implementations, the user identifiers, originally ranked alphabetically, are ranked (or re-ranked) in accordance with a predefined time range in the plurality of predefined time ranges or the total storage usage information. For example, when a user clicks on a column header (e.g., the “TOTAL”), information displayed in the first grid, including the user identifiers (e.g. in the “User” column) and storage usage information displayed in the predefined time ranges, is ranked accordingly.

In some implementations, also in response to the user selection, the computer 102-A displays (316), in a third pane, a second grid (e.g., the grid 510 in FIG. 5A). In some implementations, the second grid includes: (a) a first ranked plurality of sub-elements, and (b) storage usage information corresponding to the first ranked plurality of sub-elements. In some implementations, the second grid includes subdirectories or files under a directory selected by a user (e.g., in pane 502), as well as storage usage information associated with those subdirectories or files.

In some implementations, the computer 102-A optionally updates (318) the display of the first or second grid in accordance with a user input. In some implementations, when a user selects a different directory, storage information associated with the newly-selected directory and its subdirectories are displayed in the first grid and the second grid, respectively. For example, as first shown in FIG. 5E, when the directory “dir_{—}0132” is selected, storage information for the directory “dir_{—}0132” and its subdirectories are displayed in the grids 508 and 510 respectively; as next shown in FIG. 5F, after the directory “dir_{—}0001” is selected, information displayed in the grids 508 and 510 is updated to reflect storage usage information associated with the directory “dir_{—}0001” (rather than the directory “dir_{—}0132) and its bus directories, respectively.

In some implementations, the computer 102-A optionally displays (320) a third grid (e.g., the grid 534 in FIG. 5G), in response to a predefined user action (e.g., a click on a second tabbed pane). In some implementations, the third grid includes: (a) a second plurality of sub-elements, (b) one or more user identifiers associated with the second plurality of sub-elements, (c) storage usage information corresponding to the second plurality of sub-elements, and (d) one or more last modification timestamps associated with the second plurality of sub-elements, where the second plurality of sub-element is ranked in accordance with user identifier, last modification timestamp, or the storage usage information. In some implementations, the window in which the plurality of panes is displayed includes two or more tabs (e.g., the “Explore” tab and the “Top 100” tab in FIG. 5G). In some implementations, in response to a user click on the second tab (e.g., the “Top 100” tab 532 in FIG. 5G), the computer 102-A displays the third grid, in addition to or in place of, the first and second grids. In some implementations, the third grid includes: (a) file names, optionally with full path (e.g., sub-elements, such as entries in the “File” column 542), (b) file ownership (e.g., user identifiers or user names) associated with the files, (c) file size (e.g., storage usage information corresponding to the sub-elements), and (d) last modification timestamps indicating a time at which the files were last modified. In some implementations, where read access is more common or file usage is more accurately reflected by the number of accesses rather than the number of modifications (e.g., in a read-only database), the third grid includes one or more last access timestamps.

In some implementations, the computer 102-A optionally ranks the second plurality of sub-elements, without user intervention, upon activating the display of the third grid. In some implementations, upon activating the display of the third grid (e.g., a user click on the “Top 100” tab), filenames are sorted automatically, e.g., in an alphabetical order, before the third grid is displayed, in order to facilitate a user's review.

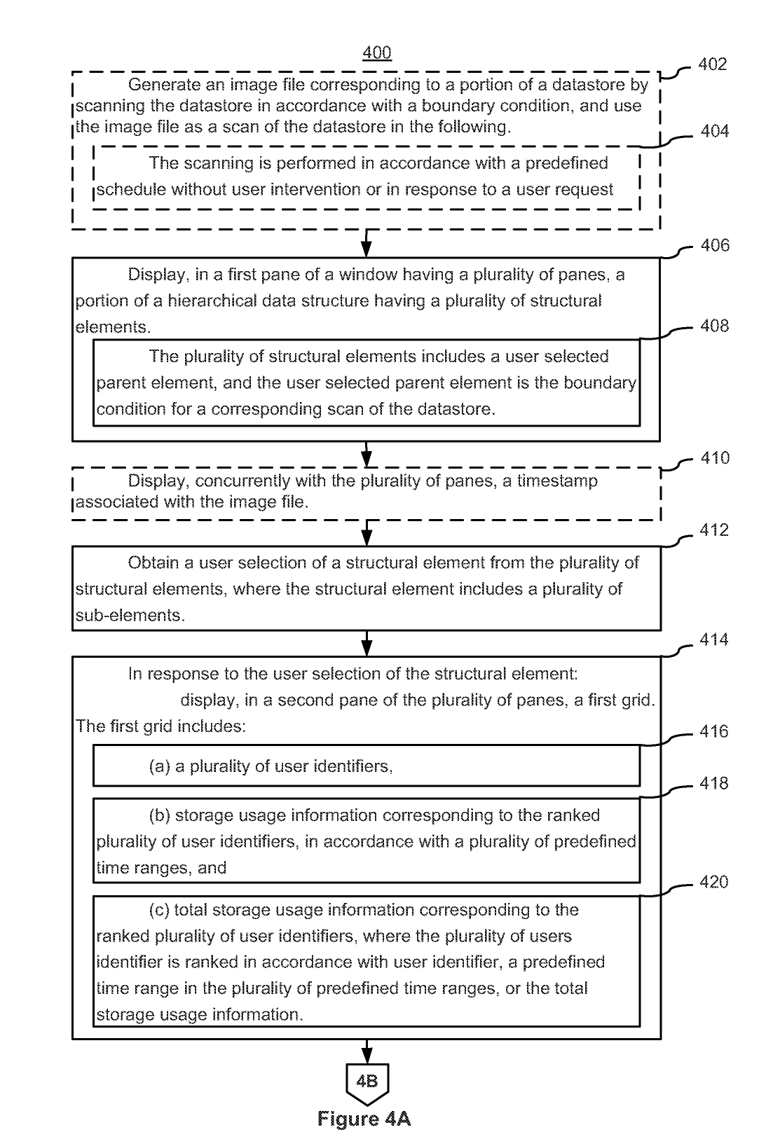

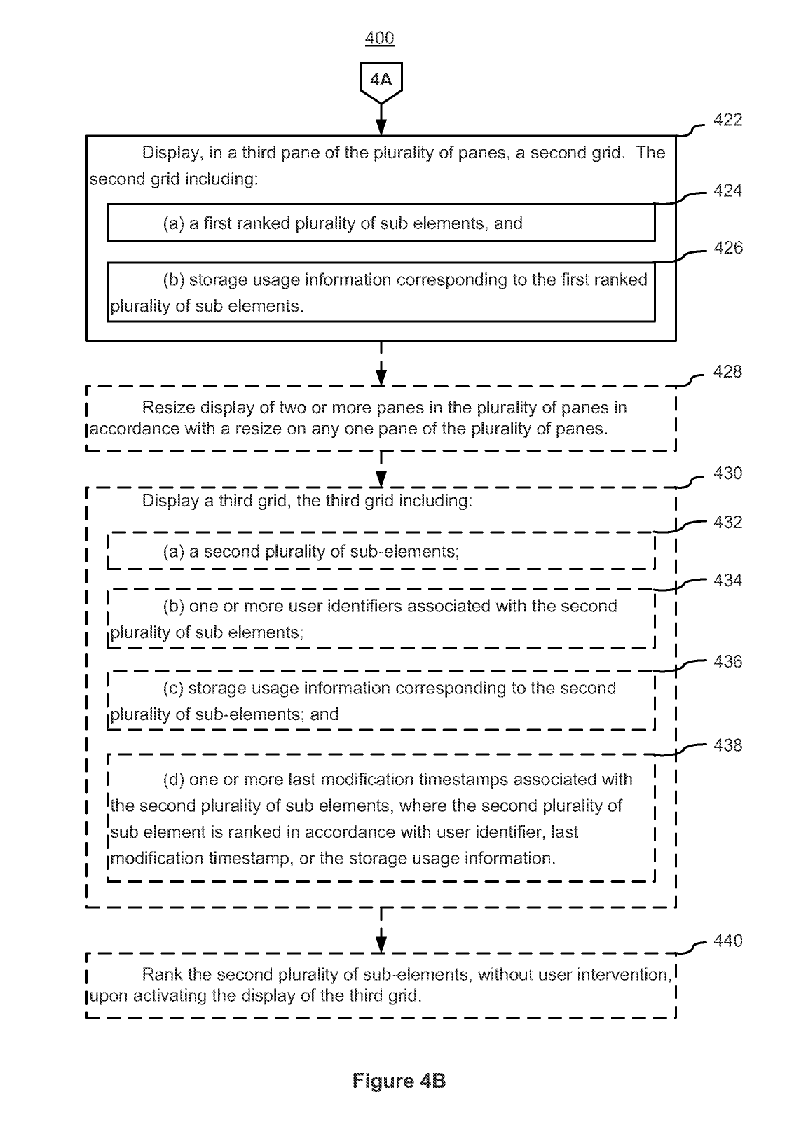

FIGS. 4A-4B are flow charts illustrating a method 400 for integrating storage usage information at a computer system, in accordance with some implementations.

In some implementations, a computer system (e.g., the computer 102-A) generates (402) an image file (e.g., an XML file, a spreadsheet or a text file) corresponding to a portion of a datastore by scanning the datastore in accordance with a boundary condition. In some implementations, one or more steps described below (e.g., 404-440) are performed using the image file.

In some implementations, the scanning process is performed (404) in accordance with a predefined schedule without user intervention (e.g., a user does not need to click or select the predefined schedule through a user interface) or in response to a user request (e.g., entered and received through one or more user interface controls). In some implementations, a predefined schedule includes: starting the scanning process every each month, or at the completion of a milestone associate with a project (in many situations, temporary data are no longer needed and can thus be removed or archived after a milestone is reached). In some implementations, the predefined schedule is imported from or determined by other project management applications, such as Microsoft Project or SAP Resource and Portfolio Management. In some implementations, the scanning process is performed during off-peak hours (e.g., non-working hours or holiday) to avoid potentially negative impact on system performance: as noted above, scanning a huge amount of data and collecting data attributes thereof may be time- and resource-consuming.

In some implementations, the scanning process is independent from the remaining steps (e.g., 406-440) (e.g., executed separately at different timing timings or on different computers). For example, the displaying steps need not occur immediately after the scanning process, or after the image file created. Instead, a user (e.g., a system administrator) may choose to execute the displaying steps at his or her own discretion (sometimes referred to as “offline”). In other implementations, the scanning process is executed together (e.g., within a predefined in interval) with the remaining steps (e.g., 406-440).

In some implementations, the image file generated by the scanning process is portable and can be shared among many users across different workgroups (e.g., a system administrator and a database manager) or among different types of users (e.g., a system administrator and a directory owner). In some implementations, image files generated over a specific time period (e.g., from the beginning to the end of a software project) are aggregated and then analyzed for statistical purposes, e.g., to predict storage usage in similar future projects. This offline approach is beneficial because it allows the scanning process and the displaying process to be executed at different timings, for example, during non-work hours and work hours, respectively. In some implementations, the image file is displayed or viewed using a Java GUI application or other light-weight process.

In some implementations, the remaining steps (e.g., 406-440) are performed by a different user, on a different computer, or at a different location (from the scanning process).

In some implementations, the computer system (or another computer system, e.g., the computer 102-B) displays (406), in a first pane of a window having a plurality of panes (e.g., the pane 504 in FIG. 5A), a portion of a hierarchical data structure having a plurality of structural elements. This plurality of structural elements includes (408) a user selected parent element, where the user selected parent element is a boundary condition for a corresponding scan of a datastore. In some implementations, the hierarchical data structure is constructed using the image file (e.g., the XML file). In some implementations, the hierarchical data structure includes a tree structure, in which files and subdirectories are sub-nodes of their common parent directory (a parent node). In some implementations, a structural element includes a directory (e.g., a root or subdirectory) having one or more its own subdirectories or files.

In some implementations, the user selected parent element is a directory selected by a user, which includes subdirectories or files. In some implementations, the user selected parent element is the root node in the hierarchical data structure (e.g., the note “dir_{—}0001” 512 in FIG. 5B). In some implementations, the user selected parent element corresponds to the boundary condition specifying the scope of the scanning process. In some implementations, the user selected parent element corresponds to a portion of (e.g., a parameter specified within) the user request 111 (e.g., “SCAN_dir_{—}0001, file_excluded, subdirectory_included”).

In some implementations, the computer system optionally displays (410), concurrently with the plurality of panes, a timestamp (e.g., the timestamp 516 in FIG. 5B) associated with the image file. In some implementations, the timestamp is displayed adjacent to but independently from the plurality of panes. In some implementations, the timestamp represents a time at which the scan was started or finished, indicative of the recentness (or lack thereof) of the image file. This is beneficial because, an image file created remote (e.g., too far ago) in time may not accurately reflect actual storage space usage at the time an analysis needs to be conducted.

In some implementations, the computer system then obtains (412) a user selection of a structural element from the plurality of structural elements, where the structural element includes a plurality of sub-elements. In some implementations, the user selected structural element is a file or a subdirectory included in the hierarchical data structure. In some implementations, the user selected structural element includes its own subdirectories or files (sub-elements). For example, in FIG. 5B, a user can click on the node “dir_{—}0002” 514, making that node the user selected structural element, and information displayed in the pane 504 and the pane 506 are updated accordingly to display storage space usage information associated with the node “dir_{—}0002” 514, rather than that associated with the node “dir_{—}0001” 512.

In some implementations, in response to the user selection of the structural element: the computer system displays (414), in a second pane of the plurality of panes, a first grid (e.g., the grid 508 in FIG. 5A). In some implementations, the first grid includes: (a) a plurality of user identifiers (416); (b) storage usage information (418) corresponding to the ranked plurality of user identifiers, in accordance with a plurality of predefined time ranges; and (c) total storage usage information (420) corresponding to the ranked plurality of user identifiers, where the plurality of users identifier is ranked in accordance with user identifier, a predefined time range in the plurality of predefined time ranges, or the total storage usage information. In some implementations, the plurality of user identifiers includes user log-in names (e.g., user names 518 in FIG. 5B). In some implementations, the user identifiers are ranked and displayed alphabetically. In some implementations, the first grid includes the storage usage information ranked in accordance with the ranked user identifiers. In some implementations, the first grid includes the storage usage information categorized by time ranges, such as, less than 7 days, between 7 and 30 days, between 30 and 90 days, between 90 and 180 days, between 180 and 1 year, between 1 year and 2 years, between 2 year and 5 years, and more than 5 years. In some implementations, the time ranges are customizable. In some implementations, the users identifier are ranked in accordance with a predefined time range in the plurality of predefined time ranges or the total storage usage information. For example, when a user clicks on a column header (e.g., the “TOTAL” column in FIG. 5B), information displayed in the first grid, including the user identifiers (e.g., the “User” column in FIG. 5B) and storage usage information displayed in the predefined time ranges, is ranked accordingly.

In some implementations, the computer system also displays (422), in a third pane of the plurality of panes, a second grid (e.g., the grid 510 in FIG. 5A). In some implementations, the second grid includes: (a) a first ranked plurality of sub-elements (424), and (b) storage usage information (426) corresponding to the first ranked plurality of sub-elements. In some implementations, the second grid includes subdirectories or files under a directory selected by a user (e.g., in pane 502), as well as storage usage information associated with those subdirectories or files. Displaying storage usage for a parent directory and its subdirectories concurrently is beneficial, because it not only gives a user a broad overview of storage usage on a directory by directory level; but also allows the user to quickly navigate down (or drill down) to a specific directory—that is located many levels deep from the directory initially selected by the user, rendering it difficult to be identified—and investigate any potential storage inefficiency.

In some implementations, the computer system resizes (428) the display of two or more panes in the plurality of panes in accordance with a resize on any one pane of the plurality of panes. In some implementations, a user can resize the first pane, to view more information displayed in the second or third panes, e.g., using a splitter. In some implementations, after detecting a resize of a pane, the computer automatically resizes the remaining panes in the plurality of panes, so as to optimize the display of the panes and to provide a user-friendly user interface.

In some implementations, the computer system optionally displays (430) a third grid (e.g., the grid 534 in FIG. 5G), in response to a predefined user action (e.g., a click on a second tabbed pane). The third grid includes: (a) a second plurality of sub-elements (432), (b) one or more user identifiers (434) associated with the second plurality of sub-elements, (c) storage usage information (436) corresponding to the second plurality of sub-elements, and (d) one or more last modification timestamps (438) associated with the second plurality of sub-elements, where, the second plurality of sub-element is ranked in accordance with user identifier, last modification timestamp, or the storage usage information. In some implementations, the window in which the plurality of panes is displayed includes two or more tabs (e.g., the “Explore” tab and the “Top 100” tab). In some implementations, in response to a user click on the second tab (e.g., the “Top 100” tab 532 in FIG. 5G), the computer displays the third grid, in addition to or in place of, the first and second grids. In some implementations, the third grid includes: (a) file names optionally with full file paths (e.g., sub-elements, such as entries in the “File” column 542), (b) file ownership (e.g., user identifiers or user names) associated with the second plurality of sub-elements, (c) file size (e.g., storage usage information corresponding to the sub-elements), and (d) last modification timestamps indicating a time in which the files were last modified. In some implementations, such as a read-only database, where file usage is more accurately reflected by the number of access rather than the number of modification, the third grid also includes one or more last access timestamps of the sub-elements.

In some implementations, the computer system optionally ranks (440) the second plurality of sub-elements, without user intervention, upon activating the display of the third grid. In some implementations, upon activating the display of the third grid (e.g., a user click on the “Top 100” tab), files names are sorted automatically, e.g., in an alphabetical order, before the third grid is displayed, in order to facilitate a user's review.

FIGS. 5A-5G are screen images illustrating example portions of a user interface for integrating storage usage information, in accordance with some implementations.

In FIG. 5A, the usage analyzer interface 500 is an example of a user interface, through which a user associated with the computer system 102 reviews data included in an image file. For example, this is done by the user selecting the image file through the “File” menu. In some implementations, the usage analyzer interface 500 displays a directory and its subdirectories and files in a first pane 502 on the left hand side, usage information in accordance with user names and several different time ranges in a second pane 504 on the upper right hand side, and usage information for subdirectories in a third pane 506 on the lower right hand side.

In FIG. 5B, after receiving a user click on the “TOTAL” column in the first grid, the usage analyzer interface 500 sorts storage usage information displayed in the second pane 504 based on the amount of total storage space consumed by a particular user. For example, as shown in FIG. 5B, information in the second pane is sorted or ranked based on the “TOTAL” column 520.

In FIG. 5C, after receiving a user click on the “Size” column in the second grid, the usage analyzer interface 500 sorts storage usage information displayed in the third pane based on the amount of total storage space consumed by a particular subdirectory. For example, as shown in FIG. 5C, information (e.g., columns 526 and 528) in the third pane is sorted or ranked based on the “Subdirectory” column 528.

In FIG. 5D, after receiving a user click on the “>5 years” column in the first grid, the usage analyzer interface 500 sorts storage usage information displayed in the second pane based on the amount of data last modified more than 5 years ago, e.g., indicative of little or no usage. For example, as shown in FIG. 5D, information in the second pane is sorted or ranked based on the “>5 years” column 530.

In FIG. 5E, the usage analyzer interface 500 expands the view of hierarchical data structure in response to a user action. In FIG. 5E, after receiving a user selection of a directory (the directory “dir_{—}0132”) displayed in the first pane, subdirectories under the user selected directory (the directory “dir_{—}0132”) are displayed, in an expanded view, in the first pane. As shown FIG. 5E, the hierarchical data structure also includes visual indicia (531) as to whether a subdirectory includes its own subdirectories.

In FIG. 5F, the usage analyzer interface 500 contracts the view of hierarchical data structure in response to a different user action. In FIG. 5F, after receiving a user selection of a parent directory (the directory “dir_{—}0001”) displayed in the first pane, subdirectories under the user selected directory are contracted (or hidden from display) in the first pane, and storage usage information in the second and third panes are updated accordingly to reflect that of the parent directory (rather than one of the subdirectories).

In FIG. 5G, the usage analyzer interface 500 displays, in a second tab, the top 100 largest (or most storage-consuming) files. In FIG. 5G, for each of the top 100 files, file size 536, last modification data and time 538, file ownership 540, and file location (e.g., file name with full path) are displayed.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first grid could be termed a second grid, and, similarly, a second grid could be termed a first grid, which changing the meaning of the description, so long as all occurrences of the “first grid” are renamed consistently and all occurrences of the “second grid” are renamed consistently. The first grid, and the second grid are both grids, but they are not the same grid.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method, comprising:
at a computer system:
displaying, in a first pane of a window having a plurality of panes, all or a portion of a hierarchical data structure having a plurality of structural elements, the plurality of structural elements including a user selected parent element, wherein the user selected parent element is a boundary condition for a corresponding scan of a datastore;
obtaining a user selection of a structural element from the plurality of structural elements, wherein the structural element includes a plurality of sub-elements;
in response to the user selection of the structural element:
displaying, in a second pane of the plurality of panes, a first grid including:
(a) a plurality of user identifiers,
(b) storage usage information corresponding to the plurality of user identifiers, in accordance with a plurality of predefined time ranges, and
(c) total storage usage information corresponding to the plurality of user identifiers, wherein, the plurality of user identifiers is ranked in accordance with user identifier, a predefined time range in the plurality of predefined time ranges, or the total storage usage information; and
displaying, in a third pane of the plurality of panes, a second grid including:
(a) a first ranked plurality of sub-elements, and
(b) storage usage information corresponding to the first ranked plurality of sub-elements.

2. The method of claim 1, further comprising:
generating an image file corresponding to all or a portion of the datastore by scanning the datastore in accordance with the boundary condition, wherein the image file serves as the corresponding scan of the datastore.

3. The method of claim 2, wherein the generating is performed in accordance with a predefined schedule without user intervention, or in response to a user request.

4. The method of claim 1, the method further comprising displaying, concurrently with the plurality of panes, a timestamp associated with the corresponding scan of the datastore.

5. The method of claim 1, the method further comprising resizing two or more panes in the plurality of panes in accordance with a resize on any one pane in the plurality of panes.

6. The method of claim 1, further comprising displaying a third grid, the third grid comprising:
(a) a second plurality of sub-elements,
(b) one or more user identifiers associated with the second plurality of sub-elements,
(c) storage usage information corresponding to the second plurality of sub-elements, and
(d) one or more last modification timestamps associated with the second plurality of sub-elements,
wherein, the second plurality of sub-element is ranked in accordance with user identifier, last modification timestamp, or the storage usage information.

7. The method of claim 6, the method further comprising: ranking the second plurality of sub-elements, without user intervention, prior to displaying the third grid.

8. The method of claim 6, the method further comprising: ranking the second plurality of sub-elements, without user intervention, upon activating the display of the third grid.

9. A computer system, comprising:
one or more processors;
memory; and
one or more programs, wherein the one or more programs are stored in the memory and are configured to be executed by the one or more processors, the one or more programs including instructions for:
displaying, in a first pane of a window having a plurality of panes, all or a portion of a hierarchical data structure having a plurality of structural elements, the plurality of structural elements including a user selected parent element, wherein the user selected parent element is a boundary condition for a corresponding scan of a datastore;
obtaining a user selection of a structural element from the plurality of structural elements, wherein the structural element includes a plurality of sub-elements;
in response to the user selection of the structural element:
displaying, in a second pane of the plurality of panes, a first grid including:
(a) a plurality of user identifiers,
(b) storage usage information corresponding to the ranked plurality of user identifiers, in accordance with a plurality of predefined time ranges, and
(c) total storage usage information corresponding to the ranked plurality of user identifiers, wherein, the plurality of users identifier is ranked in accordance with user identifier, a predefined time range in the plurality of predefined time ranges, or the total storage usage information; and
displaying, in a third pane of the plurality of panes, a second grid comprising:
(a) a first ranked plurality of sub-elements, and
(b) storage usage information corresponding to the first ranked plurality of sub-elements.

10. The computer system of claim 9, wherein the one or more programs further comprises instructions for:
generating an image file corresponding to all or a portion of the datastore by scanning the datastore in accordance with the boundary condition, wherein the image file serves as the corresponding scan of the datastore.

11. The computer system of claim 10, wherein the generating is performed in accordance with a predefined schedule without user intervention, or in response to a user request.

12. The computer system of claim 9, wherein the one or more programs further comprises displaying, concurrently with the plurality of panes, a timestamp associated with the corresponding scan of the datastore.

13. The computer system of claim 9, wherein the one or more programs further comprises instructions for resizing two or more panes in the plurality of panes in accordance with a resize on any one pane in the plurality of panes.

14. The computer system of claim 9, wherein the one or more programs further comprises instructions for displaying a third grid, including:
(a) a second plurality of sub-elements,
(b) one or more user identifiers associated with the second plurality of sub-elements,
(c) storage usage information corresponding to the second plurality of sub-elements, and
(d) one or more last modification timestamps associated with the second plurality of sub-elements,
wherein, the second plurality of sub-element is ranked in accordance with user identifier, last modification timestamp, or the storage usage information.

15. The computer system of claim 14, wherein the one or more programs further comprises instructions for ranking the second plurality of sub-elements, without user intervention, prior to displaying the third grid.

16. The computer system of claim 14, wherein the one or more programs further comprises instructions for ranking the second plurality of sub-elements, without user intervention, upon activating the display of the third grid.

17. A non-transitory computer readable storage medium storing one or more programs, the one or more programs comprising instructions, which when executed by a computer system with one or more processors, cause the computer system to:
display, in a first pane of a window having a plurality of panes, all or a portion of a hierarchical data structure having a plurality of structural elements, the plurality of structural elements including a user selected parent element, wherein the user selected parent element is a boundary condition for a corresponding scan of a datastore;
obtain a user selection of a structural element from the plurality of structural elements, wherein the structural element includes a plurality of sub-elements;
in response to the user selection of the structural element:
display, in a second pane of the plurality of panes, a first grid including:
(a) a plurality of user identifiers,
(b) storage usage information corresponding to the ranked plurality of user identifiers, in accordance with a plurality of predefined time ranges, and
(c) total storage usage information corresponding to the ranked plurality of user identifiers, wherein, the plurality of users identifier is ranked in accordance with user identifier, a predefined time range in the plurality of predefined time ranges, or the total storage usage information; and
display, in a third pane of the plurality of panes, a second grid including:
(a) a first ranked plurality of sub-elements, and
(b) storage usage information corresponding to the first ranked plurality of sub-elements.

18. The non-transitory computer readable storage medium of claim 17, wherein the one or more programs further comprise instructions, which when executed by the computer system, cause the computer system to:
generate an image file corresponding to all or a portion of the datastore by scanning the datastore in accordance with the boundary condition, wherein the image file serves as the corresponding scan of the datastore.

19. The non-transitory computer readable storage medium of claim 18, wherein the scanning is performed upon a predefined schedule without user intervention, or upon a user demand.

20. The non-transitory computer readable storage medium of claim 17, wherein the one or more programs further comprise instructions, which when executed by the computer system, cause the computer system to:
display, concurrently with the plurality of panes, a timestamp associated with the image file.

21. The non-transitory computer readable storage medium of claim 17, wherein the one or more programs further comprise instructions, which when executed by the computer system, cause the computer system to:
resize display of two or more panes in the plurality of panes in accordance with a resize on any one pane of the plurality of panes.

22. The non-transitory computer readable storage medium of claim 17, wherein the one or more programs further comprise instructions, which when executed by the computer system, cause the computer system to:
display a third grid, the third grid including:
(a) a second plurality of sub-elements,
(b) one or more user identifiers associated with the second plurality of sub-elements,
(c) storage usage information corresponding to the second plurality of sub-elements, and
(d) one or more last modification timestamps associated with the second plurality of sub-elements,
wherein, the second plurality of sub-elements is ranked in accordance with user identifier, last modification timestamp, or the storage usage information.

23. The non-transitory computer readable storage medium of claim 22, wherein the one or more programs further comprises instructions for ranking the second plurality of sub-elements, without user intervention, prior to displaying the third grid.

24. The non-transitory computer readable storage medium of claim 22, wherein the one or more programs further comprises instructions for ranking the second plurality of sub-elements, without user intervention, upon activating the display of the third grid.
